(19) United States
(12) Patent Application Publication
(10) Pub. No.: US 2003/0041491 A1
(43) Pub. Date: Mar. 6, 2003

(54) Flame simulation apparatus and methods

(76) Inventor: Devin Eugene Mix, Lakeville, MN (US)

Correspondence Address: MERCHANT & GOULD PC, P.O. BOX 2903, MINNEAPOLIS, MN, 55402-0903, US

(21) Appl. No.: 09/941,400

(22) Filed: Aug. 28, 2001

(51) Int. Cl. G09F 19/00

(52) U.S. Cl. 40/428

(57) ABSTRACT

A flame simulation apparatus for use in electric fireplaces is disclosed. The flame simulation apparatus is disposed within a fireplace enclosure to simulate a natural fire. The flame simulation apparatus includes a flame element and a device to alter the position of the flame element relative to a fixed position. Methods for simulating a natural fire are also disclosed.

### FIELD OF THE INVENTION

The present invention relates to fireplaces. More particularly, the fireplace includes a flame simulation apparatus to simulate a fire within an enclosure.

### BACKGROUND OF THE INVENTION

Fireplaces are an efficient method for providing warmth and creating the appeal of a fire within a room. Fireplaces have become commonplace in today's building trades for both residential and commercial applications. Most new home construction designs include at least one, and often several fireplaces. Further, a significant number of remodeling projects are focused on fireplaces. Gas, electric, and wood-burning fireplaces are commonly installed within these new constructions. One of the major concerns with gas and electric fireplaces is generating a natural looking flame to simulate a fire that would typically be seen in a wood-burning fireplace.

When simulating a fire in a gas or electric firebox, it is often difficult to produce the natural look of a flame or a burning log effect. In present electric fireplace constructions, the devices used to simulate flames and flame effects are often masked with smoked or frosted glass or a mesh screen to prohibit a viewer from seeing their artificial nature. Further, other present electric fireplace constructions require a screen onto which a flame effect is projected or a partial mirror to attempt to portray a realistic flame. Some present flame simulation devices use fabric, light, and air to simulate a flame. However, none of these devices provide for movement of a flame element from a fixed position to simulate a flame that can be used in a fireplace and in other types of constructions. Because of this, these devices fail to produce a realistic flame effect and reduce the overall aesthetic value of the fireplace.

Thus, there is still a need for additional innovations in flame simulation devices for use in electric fireplaces to provide a more realistic simulated flame.

### SUMMARY OF THE INVENTION

Generally, the present invention relates to fireplaces. The fireplace can include a flame simulation apparatus used to simulate the flames of a fire.

In one aspect, the invention relates to a fireplace for simulating a natural fire, comprising a front panel and a flame simulation apparatus viewable through the front panel, wherein the flame simulation apparatus comprises a flame element coupled to a device that alters the position of the flame element.

In another aspect, the invention relates to a fireplace for simulating a natural fire comprising an enclosure defining a chamber, a flame element disposed within the chamber, and a device coupled to the flame element to alter the position of the flame element.

In another aspect, the invention relates to a flame simulation apparatus for simulating a fire, the flame simulation apparatus comprising a flame element, and a mechanical means coupled to the flame element that moves the flame element from a fixed position.

In another aspect, the invention relates to a flame simulation apparatus for simulating a fire, the flame simulation apparatus comprising an enclosure defining a chamber, and a flame simulation apparatus disposed within the chamber, wherein the flame simulation apparatus comprises a flame element coupled to a mechanical means for moving the flame element from a fixed position.

In another aspect, the invention relates to a method for simulating a flame of a fire, comprising the steps of providing a flame element; and coupling the flame element to a mechanical means that moves the flame element from a fixed position.

In another aspect, the invention relates to a method for simulating a flame of a fire, comprising the steps of providing an enclosure, wherein the enclosure defines a chamber, disposing a flame element within the chamber, and coupling the flame element to a mechanical means that moves the flame element from a fixed position.

The above summary of the present invention is not intended to describe each disclosed embodiment or every implementation of the present invention. Figures in the detailed description that follow more particularly exemplify embodiments of the invention. While certain embodiments will be illustrated and describing embodiments of the invention, the invention is not limited to use in such embodiments.

### BRIEF DESCRIPTION OF THE DRAWINGS

The invention may be more completely understood in consideration of the following detailed description of various embodiments of the invention in connection with the accompanying drawings, in which:

FIG. 1 is a schematic perspective view of one embodiment of a fireplace including embodiments of a flame simulation apparatus;

FIG. 2 is schematic front view of the fireplace including embodiments of the flame simulation apparatus of FIG. 1;

FIG. 3 is a schematic top cross-sectional view of the fireplace of FIG. 2 along line A-A, including embodiments of the flame simulation apparatus of FIG. 1;

FIG. 4 is a schematic side cross-sectional view of the fireplace of FIG. 2 along line B-B, including embodiments of the flame simulation apparatus of FIG. 1;

FIG. 5 is a schematic perspective view of one embodiment of a flame simulation apparatus;

FIG. 6 is a schematic perspective view of a second embodiment of a flame simulation apparatus;

FIG. 7 is a schematic perspective view of a second embodiment of a fireplace including one embodiment of a flame simulation apparatus; and

FIG. 8 is a schematic exploded view of the fireplace including the embodiment of the flame simulation apparatus of FIG. 8; and

FIG. 9 is a schematic perspective view of an embodiment of a fireplace insert including embodiments of the flame simulation apparatus.

While the invention is amenable to various modifications and alternant forms, specifics thereof have been shown by way of example and the drawings, and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE PREFERRED EMBODIMENTS

The invention is applicable to fireplaces. In particular, the invention is directed to a fireplace including a flame simulation apparatus. While the present invention is not so limited, an appreciation of the various aspects of the invention will be gained through a discussion of the examples provided below.

The general structure of the fireplace includes a flame simulation apparatus disposed within an enclosure. The construction offers simple, realistic, easy to install, three-dimensional, and cost effective fireplaces. The simulation of a fire eliminates the need for physical presence of items such as a burner system, a gas line, and ductwork for exhaustion of combustion gases, thus reducing the overall area needed for installation of and potentially the cost associated with the fireplace. It will be understood that as used herein, the term “enclosure” can be any structure that at least partially surrounds the flame simulation apparatus and is not intended to be limited to enclosures used in fireplace constructions.

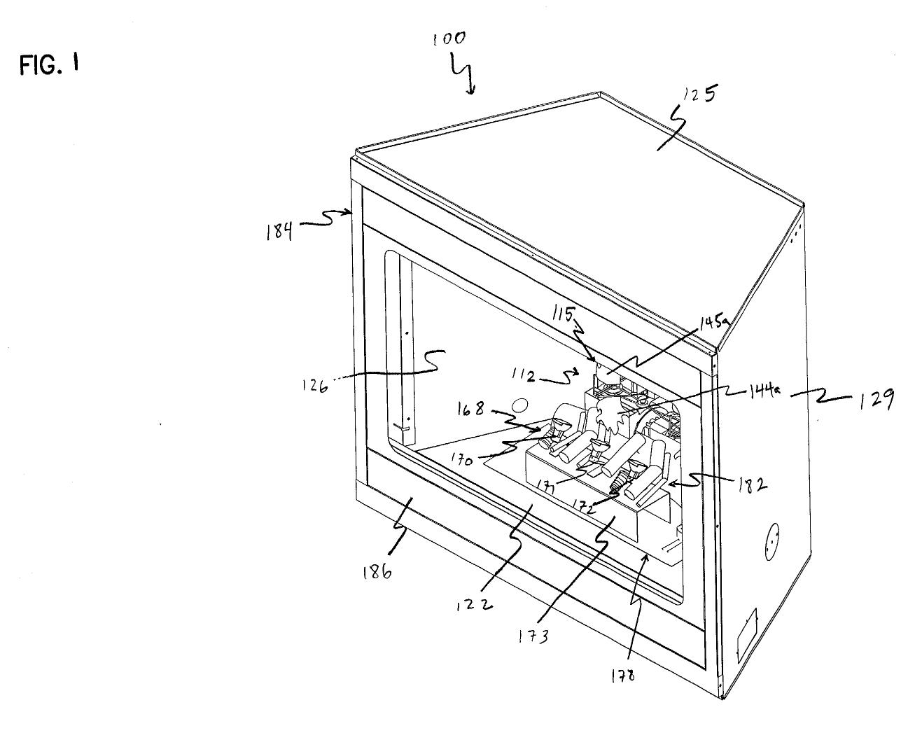

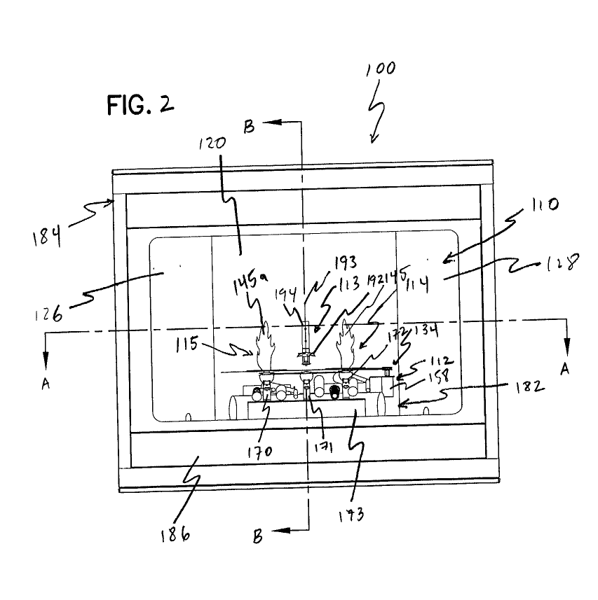

Referring to FIGS. 1 and 2, perspective and front schematic views of one embodiment of a fireplace 100 are shown. The fireplace 100 includes an enclosure 110 that houses a flame simulation apparatus 112. The flame simulation apparatus 112 includes a flame element assembly 114 to simulate a natural fire. The flame simulation apparatus 112 provides a three-dimensional simulation of a fire within the fireplace enclosure 110.

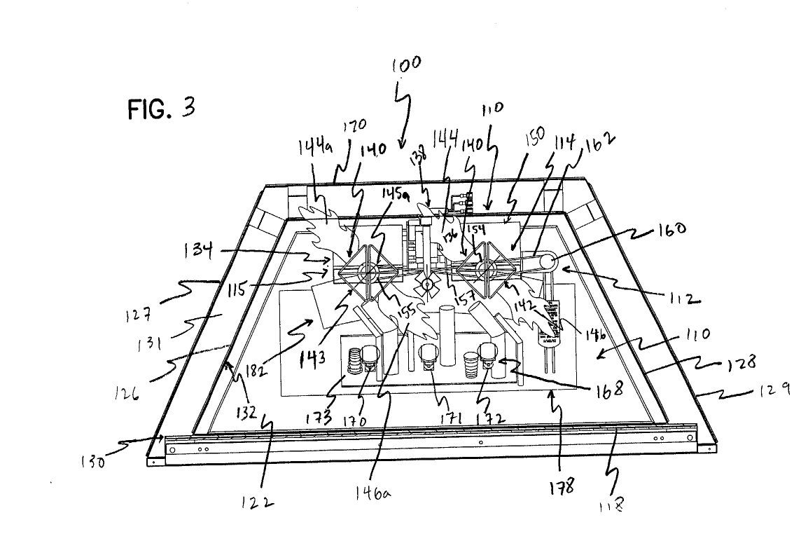

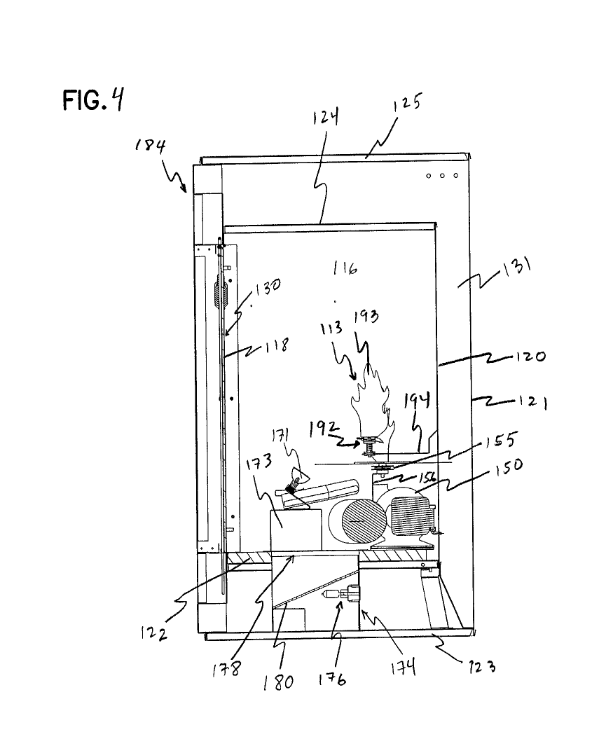

Referring to FIGS. 3 and 4, schematic top and side cross-sectional views of the fireplace 100 of FIG. 1 are shown. Fireplace 100 is of a type that is typically inserted into existing masonry fireplaces. It should be understood that the flame simulation apparatus 112 used in fireplace 100 can be used in the construction of any simulated fireplace (free-standing, framed-in, insert, etc.).

The enclosure 110 defines a chamber 116. The flame simulation apparatus 112 is disposed within the chamber 116. The chamber 116 can be any space that may be defined by the enclosure 110 or alternatively, in whole or in part, by some other structure such as a wall of a building or home.

In one embodiment, the enclosure 110 includes a front panel 118, a rear panel 120, a bottom panel 122, a top panel 124, and side panels 126, 128 as shown in FIGS. 3 and 4. In some embodiments, one or more of the front panel 118, rear panel 120, bottom panel 122, top panel 124, and side panels 126, 128 can be eliminated from the enclosure 110 construction. Optionally, the fireplace construction can also include an outer rear panel 121, outer bottom panel 123, outer top panel 125, and outer side panels 127, 129 that surround the enclosure 110. The enclosure 110 and the outer panels create a passageway 131 in which a heater (not shown) can be disposed.

The front panel 118 can be, for example, a translucent material such as glass, ceramic, or plastic to allow viewing of the flame simulation apparatus 112 therethrough. In other embodiments, the front panel 118 can be a thermally transformable front wall that converts from opaque to less opaque upon heating as described and discussed below as convertible heated glass apparatus 130 and shown in FIGS. 2 and 3. In other embodiments, the front panel 118 can be colored to further enhance the simulation of the flame. In yet other embodiments, the front panel 118 can be textured, include a pattern, or contain lines to increase the natural look of the flame and fire.

A textured and/or colored pane of glass can be used as part of the front panel 118 of the enclosure 110. In other embodiments, one or more of rear panel 120, bottom panel 122, top panel 124, and side panels 126, 128 can include, in whole or part, a textured and/or colored pane of glass. Optionally, the rear panel 120 and side panels 126, 128 can include a partial mirrored surface 132. The partial mirrored surface 132 reflects flame element assembly 114 to enhance the flame simulation effect by creating additional depth of the flame element assembly 114. Alternatively, the rear panel and side panels can include a completely mirrored surface to reflect the flame element.

The front panel 118 can also be used to generate heat. A convertible heated glass apparatus 130 can form a front wall of the fireplace 100. The apparatus 130 includes a phase change material that converts between an opaque solid and a less opaque liquid. When the phase change material is an opaque solid, an observer cannot view through the glass into the fireplace enclosure 110. The convertible heated glass apparatus 130 can be obtained from Pleotint L.L.C. located in West Olive, Mich., under the product name ThermoSee™. One or more electric heaters (not shown) having an associated blower can be disposed within the fireplace 100 to further generate and provide heat.

Alternatively, other structures can be used to house the flame simulation apparatus. For example, a flame simulation apparatus can be disposed within an enclosure having at least one panel through which the flame simulation apparatus can be viewed such as a panel that forms the base of a table. The flame simulation apparatus can also be disposed within a structure that forms, for example, the top of a table.

Referring to FIGS. 2 and 3, a single flame simulation apparatus 112 is shown. In other embodiments, one or multiple flame simulation apparatuses can be disposed within the enclosure 110. The flame simulation apparatus 112 includes the flame element assembly 114 coupled to a device 134 that alters the position of the flame element assembly 114 to simulate a fire. Altering the position of the flame element means any type of movement of the flame element including, but not limited to, wavering, rippling, flickering, rotation, and movement in any horizontal and/or vertical direction.

In some embodiments, the flame simulation apparatus 112 can include multiple flame element assemblies 114, 115 mounted at various locations within the enclosure 110 and coupled to the device 134. Each flame element assembly can be coupled to its own device to alter the position of the flame element or a single device, as shown in FIG. 3, that is coupled to multiple flame element assemblies 114, 115.

The flame element assembly 114 can include multiple flame elements coupled to a flame element mounting frame 142. For example, as shown in FIGS. 2 and 3, flame elements 144, 145, 146 are attached to the flame element mounting frame 142 of flame element assembly 114. Alternatively, any number of individual flame elements can be attached to the flame element mounting frames 142. For example, a single flame element, such as element 145 can be couple to device 134. Flame element assembly 115 can also include multiple flame elements 144a, 145a, 146a coupled to a second flame element mounting frame 143. Flame element mounting frame 142 and second flame element mounting frame 143 can have any shape that allows for the attachment of one or more flame elements.

The flame element assembly 114 can be mounted to the fireplace enclosure 110 by coupling the flame element mounting frame 142 to the device 134, as shown in FIGS. 3 and 4. The bottom edge portion 140 of the flame element assembly 114 can be attached to the flame element mounting frame 142 with adhesive, tape, Velcro, a pressure fit, or any other suitable means for attachment, to allow for the free movement of a body portion 136 of the flame element assembly 114.

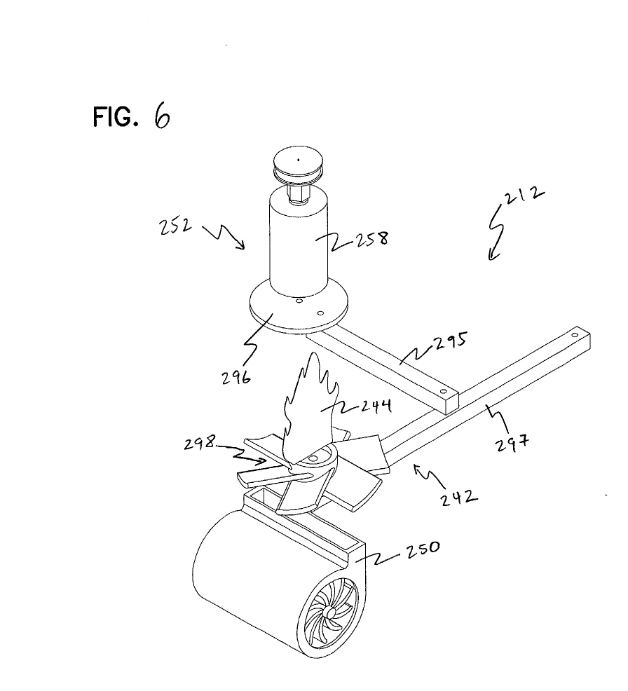

Alternatively, a single flame element can be directly connected to the device, as shown, for example, in the embodiment of the flame simulation apparatus in FIG. 6. In such an embodiment, the flame element can be directly coupled with adhesive or other suitable means to the device without using the flame element mounting frame.

Referring to FIG. 3, flame element 144 includes the body portion 136 and an edge portion 138. The edge portion 138 includes a bottom edge portion 140. The edge portion 138 can be treated with a stiffening material or compound such as Fray-Check, which is available from Prym-Dritz Corporation located in Spartansburg, S.C. After applying the stiffening material or compound, the edge portion 138 becomes a supple solid. This construction for the edge portion 138 prevents the flame element 144 from fraying due to friction and dynamic forces generated by a blown air stream from blower 150 and movement created through rotation of flame element 144. The edge portion of any flame element used in the flame simulation apparatus can be treated similar to flame element 144.

Raw fabric or other materials can be used for the flame element such as nylons, plastics, silks, cottons, wools, and composites of fabrics and materials. Any lightweight, supple, semi-transparent, or semi-reflective material can be used as flame element. The flame elements described herein include a raw chiffon-type silk material. The flame elements can be cut from the raw material into any desired shape to simulate the flames of a fire. The raw material is cut into a general flame shape, as shown in FIG. 4.

Several different embodiments of device 134 can be used in the construction of fireplace 100 to generate the flame simulation effect. In one embodiment, device 134 includes blower 150 positioned to blow air onto flame element assembly 114 (FIGS. 2 and 3) to generate movement and the appearance of a natural flame. Any air-moving device can be used to generate the airflow that alters the position of the flame element assembly 114. Blower 150 includes, but is not limited to, any device or apparatus that provides airflow or the movement of air. The blower 150 is positioned on the bottom panel 122 and is disposed within chamber 116. The blower 150 directs airflow onto the flame element assembly 114. Alternatively, the blower, or other air-moving device, can be positioned to pass air from the surroundings of and through an opening that is defined by the enclosure. The air can also be moved with convection currents that are generated by elements that generate heat, such as a light source.

Airflow directed by the blower 150 from between the bottom edge portion 134 and the bottom panel 122 suspends the flame element assembly 114 in an upright position for viewing. The flame element assembly 114 waivers and simulates the movement of a flickering fireplace flame. Alternatively, a blower can be positioned between top panel and flame element to generate an upward airflow and to draw the flame element up to an upright position. The air can then be passed into and through a passageway that directs the air onto the flame element, similar to a blower being positioned between the bottom edge portion and the bottom panel.

Referring to FIGS. 3-5, a second embodiment of device 134 includes a mechanical means 152 that moves the flame element assembly 114 from a fixed position. It is understood that any mechanical means that moves a flame element assembly 114 from a fixed position can be employed to simulate a natural flame. A fixed position means the position in which the flame element assembly 114 exists without employing a mechanical means to rotate the flame element assembly 114 and/or move the flame element assembly 114 in a horizontal and/or vertical direction.

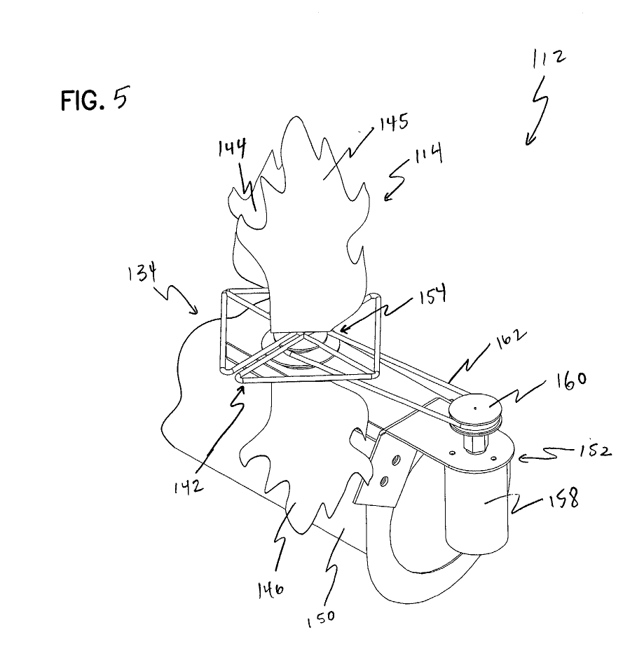

Mechanical means 152 generates rotation of the flame element assembly 114. Rotation of the flame element assembly 114 creates three-dimensional movement and flame simulation. Mechanical means 152 includes an idler pulley 154 that is coupled to flame element assembly 114 through the flame element mounting frame 142. Idler pulley 154 can be coupled to a second idler pulley 155 with idler belt 157, as shown in FIG. 3. Idler pulley 155 is coupled to the second flame element mounting frame 143 to provide rotation of the flame elements 144a, 145a, 146a attached to the frame 143. In other embodiments, for example, as shown in FIG. 5, a single idler pulley 154 can be used to rotate a single flame element assembly 114.

Idler pulleys 154, 155 can include low friction bushings or bearings to provide free rotation of the flame element assembly 114. Referring to FIG. 4, the second idler pulley 155 is mounted to the blower 150 with a mounting bracket 156. Alternatively, the idler pulley can be mounted to the enclosure or any structure disposed within the chamber. Idler pulley 154 can be similarly mounted.

The idler pulley 154 is operatively connected to an electric motor 158 through a drive pulley 160 that is driven by electric drive motor 158. A drive belt 162 couples the drive pulley 160 to the idler pulley 154 to produce rotary motion of the flame element assembly 114. Rotation of the idler pulley 154 generates rotation of the flame element mounting frame 142. This in turn rotates any flame element, for example, flame element assembly 114, that is coupled to the flame element mounting frame 142.

Rotation of one or more flame element assemblies 114, 115 generates a more realistic, three-dimensional simulated flame. Flame element assembly 115 is rotated in a clockwise fashion. Flame element 114 disposed is rotated in a counter clockwise fashion. The direction of rotation and other directions of movement of the flame element can be selected to provide any desired simulated flame effect.

In some embodiments, the flame simulation apparatus 112 includes a light source 168. The light source 168 is directed at the flame element assembly 114 to illuminate the flame element assembly 114 to simulate the coloring of natural flames. Alternatively, the light source can generate heat that provides a source of convection current to assist in the suspension of the flame element in an upright position.

The light source 168 can include, for example, one or more light bulbs to project the light onto the flame element assembly 114. The light bulb or bulbs can be positioned as desired within the fireplace enclosure 110 to achieve a desired flame simulation effect. For example, as shown in FIG. 3, the light source 168 includes three light bulbs 170, 171, and 172 positioned on a support panel 173. Optionally, colored light bulbs can be used to generate the light directed on to the flame element assembly 114. A wide variety of colored lights can be used to generate a desired coloration on the flame element assembly 114. For example, a combination of blue, yellow, orange, and/or red colored lights can be used to simulate the flame. The light generated from the light bulbs can also pass through colored plastic, such as Kapton, or stained glassed to generate a desired color or pattern that is directed onto the flame element assembly 114. As shown in FIG. 2, the light source 168 can generate light from at least two sides of the flame element assembly 114.

In some embodiments, simulated glowing ember system 174 can also be used to enhance the aesthetic appeal of the fireplace 100. Referring to FIG. 4, the simulated glowing ember system 174 can include an ember light source 176 positioned below an ember support structure 178 on which translucent artificial embers (not shown) are disposed. A colored plate 180 can be positioned between the ember light source 176 and the ember support structure 178 to enhance the coloring of the translucent artificial embers. The translucent artificial embers preferably should perform in temperatures without foaming or breaking up and also is semi-transparent to allow light to pass through them to simulate glowing. For example, fused silica particles can be used for the translucent artificial embers. The material utilized for the translucent artificial embers in one embodiment of the invention can be a fused silica material, such as a material manufactured by C-E Minerals, located in King of Prussia, Pa., and sold under the Teco-Sil® mark. Teco-Sil® silica is a high purity fused silica with greater than 99% non-crystalline SiO₂. Less than 1% of Teco-Sil® silica includes Cristobalite. Teco-Sil® silica has a melting point of greater than 3000 degrees Fahrenheit. It should be understood, however, that other translucent, high temperature material could also be used to make the translucent artificial embers.

Paint or other darkening material can be applied to the surface of a translucent artificial ember. An individual translucent artificial ember can be provided, for example, with paint applied to at least a portion of the surface of the ember. Paint can be applied to the plurality of translucent artificial embers of an ember bed to give the effect of a bed having “cool” ember top and a hot glowing underside. The paint, typically a black or charcoal color, may be applied to a portion of translucent artificial embers or to all of them. Other colorization sources besides paint may also be used, such as, for example, pigmentation that could be added during manufacturing of the translucent artificial embers.

The light generated by ember light source 176 passes through the ember support structure 178 and onto the translucent artificial embers. Alternatively, the light source can be positioned in any location that provides light to translucent artificial embers, such as disposing the light source on a raised floor. The translucent artificial embers are constructed to pass at least a portion of the light generated by ember light source 176 through them so as to simulate glowing embers. The ember support structure 178 includes any material that allows light to pass to the translucent artificial embers, such as a translucent or clear glass panel or a wire mesh screen.

Optionally, a log set 182 can be used to further enhance the look of the simulated fire. The log set 182 can be disposed at any desired location within the chamber 116. Referring to FIG. 2, the log set 182 is disposed between the front panel 118 and the flame element assemblies 114, 115. Optionally, pine cones, sticks, and other items can be included with the log set to enhance the natural look of the simulated fire. Part or all of the log set 182 can be placed upon a support panel 173, or alternatively a fireplace grate (not shown), to support the log set 182 above the bottom panel 122 of the enclosure 110. The flame simulation apparatus 112 can also be integrated into log set 182 to create a single unit construction.

A decorative assembly 184 can be used to cover the front panel 118 as well as a control panel (not shown). The control panel can include switches and rheostats that regulate, for example, lighting from light sources 168 and 178, speed of electric drive motor 158, speed of blowers 150, temperature of heated glass apparatus 130, and temperature of electric heater (not shown). A decorative frame 186 that covers the outer edge of the front panel 118 of the fireplace 100 can optionally be used. Also, a fireplace grate (not shown) can be placed in the enclosure 110.

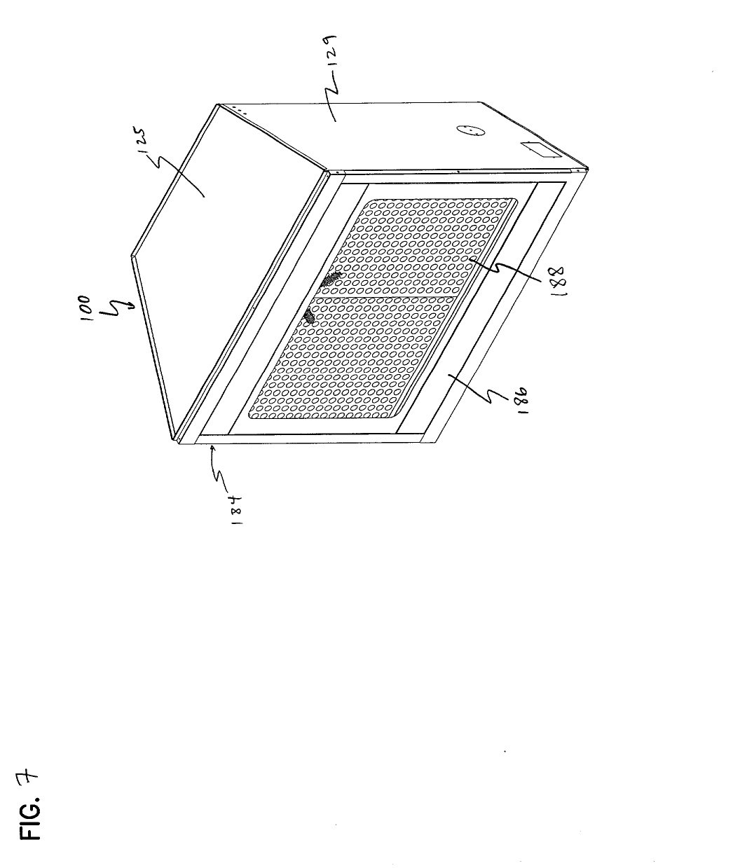

Referring to FIG. 7, another embodiment of flame simulation apparatus 212 is shown. Flame simulation apparatus 212 includes mechanical means 252. Mechanical means 252 includes an electric drive motor 258 coupled to a flame element mounting frame 242 through a drive shaft 295. The drive shaft 295 is operatively connected to electric drive motor 258 through a reciprocating assembly that includes a rotatable disk 296. The drive shaft 295 is pivotably connected at one end to the disk 295 and at its other end to the flame element mounting frame 242.

The flame element mounting frame 242 can be any structure that supports a flame element 214. Referring to FIG. 5, the flame element mounting frame 242 includes a shaft portion 297 and, optionally, a fan portion 298 rotatably connected to the shaft portion 297. The flame element mounting frame 242 can be coupled to a blower 250, or any other suitable air moving device, to generate rotation of the fan portion 298 and the flame element 214, coupled thereto.

In other embodiments, device 134 can include blower 150 and/or any one or more of embodiments of the device 134, such as mechanical means 152 and 252 or any other suitable mechanical means that moves the flame element assembly 114 from a fixed position. Rotation of flame elements such as flame element assemblies 114, 115 can alternatively be accomplished using any other movement devices or mechanical means such as a chain and sprocket assembly, gears, or a magnetic assembly. For example, the magnetic assembly can include at least one electromagnet and several neodymium magnets positioned to rotate the flame element.

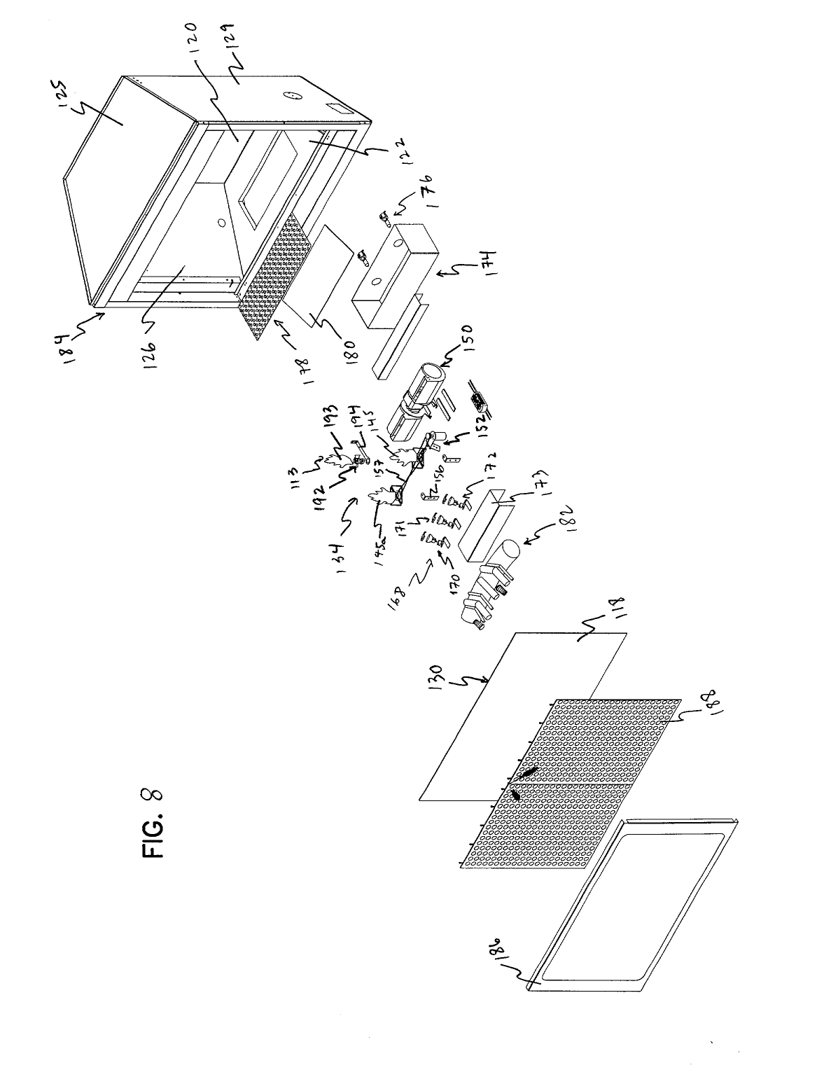

Referring to FIG. 8, a mesh screen 188 can be coupled to the decorative assembly 184 of fireplace 100. FIG. 8 is schematic exploded view of fireplace 100, including mesh screen 188.

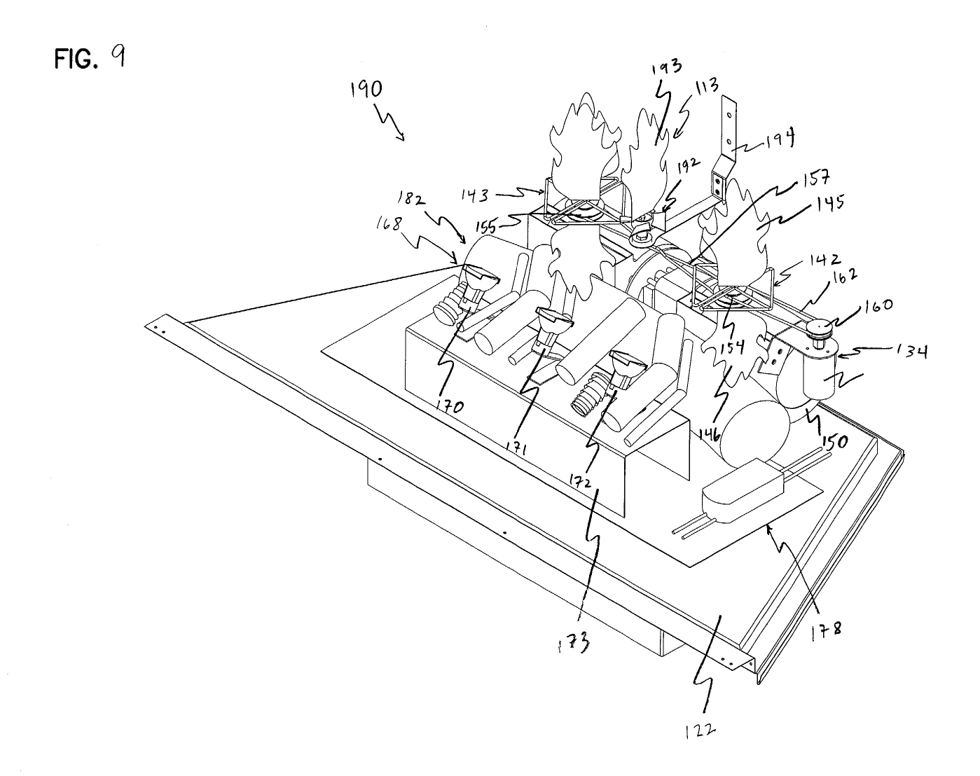

Referring to FIG. 9, a schematic perspective view of a fireplace insert 190 is shown. The fireplace insert 190 includes the bottom panel 122 of fireplace 100 supporting flame simulation apparatus 112. The construction shown in FIG. 9 is suitable for installation in an existing masonry or other fireplace construction. The bottom panel 122 can be shaped to fit within such constructions. Optionally, flame simulation apparatus 113 can be included in fireplace insert 190 construction. Flame simulation apparatus 113 includes a fan portion 192 attached to a mounting bracket 194. A flame element 193 is coupled to the fan portion 192 with adhesive, tape, Velcro, a pressure fit, or any other suitable means for attachment. The mounting bracket 194 can be attached to any structure, such as rear panel 120, or other structure, for example, the wall of an existing masonry fireplace. Blower 150 can direct airflow that rotates the fan portion 192.

The present invention should not be considered limited to the particular examples or materials described above, but rather should be understood to cover all aspect of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. A fireplace for simulating a natural fire, comprising:
a front panel; and
a flame simulation apparatus viewable through the front panel, wherein the flame simulation apparatus comprises a flame element coupled to a device that alters the position of the flame element.

2. The fireplace of claim 1, wherein the device comprises a blower positioned to blow air upon and alter the position of the flame element.

3. The fireplace of claim 1, wherein the device comprises a mechanical means to move the flame element from a fixed position.

4. The fireplace of claim 3, wherein the mechanical means comprises an electric motor coupled to a drive pulley and a drive belt coupling the drive pulley to an idler pulley; and wherein the flame element is coupled to the idler pulley to produce rotary motion of the flame element.

5. The fireplace of claim 1, wherein the device comprises:
a blower coupled to the flame element to alter the position of the flame element; and
a mechanical means to move the flame element from a fixed position.

6. The fireplace of claim 5, wherein the mechanical means comprises:
an electric motor coupled to a drive pulley and a drive belt coupling the drive pulley to an idler pulley; and wherein the flame element is coupled to the idler pulley to produce rotary motion of the flame element.

7. The fireplace of claim 1, further comprising a light source positioned to direct light upon the flame element.

8. The fireplace of claim 1, wherein the flame element comprises a silk material.

9. The fireplace of claim 1, wherein the flame element comprises a body portion and an edge portion; and wherein the edge portion is treated with a stiffening material.

10. The fireplace of claim 1, further comprising a back panel and side panels enclosing the flame simulation apparatus, wherein the back panel and side panels comprise a partial mirrored surface to produce a reflection of the flame element.

11. The fireplace of claim 1, further comprising a log set positioned between the front panel and the flame element.

12. A fireplace for simulating a natural fire comprising:
an enclosure defining a chamber;
a flame element disposed within the chamber; and
a device coupled to the flame element to alter the position of the flame element.

13. The fireplace of claim 12, wherein the device comprises a blower positioned to alter the position of the flame element.

14. The fireplace of claim 12, wherein the device comprises a mechanical means to move the flame element from a fixed position.

15. The fireplace of claim 14, wherein the mechanical means comprises an electric motor coupled to a drive pulley and a drive belt coupling the drive pulley to an idler pulley; and wherein the flame element is coupled to the idler pulley to produce rotary motion of the flame element.

16. The fireplace of claim 12, wherein the device comprises:
a blower coupled to the flame element to alter the position of the flame element; and
a mechanical means to move the flame element from a fixed position.

17. The fireplace of claim 16, wherein the mechanical means comprises an electric motor coupled to a drive pulley and a drive belt coupling the drive pulley to an idler pulley; and wherein the flame element is coupled to the idler pulley to produce rotary motion of the flame element.

18. The fireplace of claim 12, further comprising a light source positioned to direct light upon the flame element.

19. The fireplace of claim 12, wherein the flame element comprises a silk material.

20. The fireplace of claim 12, wherein the flame element comprises a body portion and an edge portion; and wherein the edge portion is treated with a stiffening material.

21. The fireplace of claim 12, wherein the enclosure comprises a front panel, a back panel, a bottom panel, a top panel and side panels; and wherein the back panel and side panels comprise a partial mirrored surface to produce a reflection of the flame element.

22. The fireplace of claim 12, further comprising a log set disposed within the chamber.

23. A flame simulation apparatus for simulating a fire, the flame simulation apparatus comprising:
a flame element; and
a mechanical means coupled to the flame element that moves the flame element from a fixed position.

24. The flame simulation apparatus of claim 23, wherein the mechanical means comprises an electric motor coupled to a drive pulley and a drive belt coupling the drive pulley to an idler pulley, wherein the flame element is coupled to the idler pulley to produce rotary motion of the flame element.

25. The flame simulation apparatus of claim 23, further comprising a light source positioned to direct light upon the flame element.

26. The flame simulation apparatus of claim 23, wherein the flame element comprises a silk material.

27. The flame simulation apparatus of claim 23, wherein the flame element comprises a body portion and an edge portion; and wherein the edge portion is treated with stiffening material.

28. The flame simulation apparatus of claim 23, further comprising the step of providing a blower coupled to the flame element to alter the position of the flame element.

29. An apparatus for simulating a fire, the apparatus comprising:
an enclosure defining a chamber; and
a flame simulation apparatus disposed within the chamber, wherein the flame simulation apparatus comprises a flame element coupled to a mechanical means for moving the flame element from a fixed position.

30. The apparatus of claim 29, wherein the mechanical means comprises an electric motor coupled to a drive pulley and a drive belt coupling the drive pulley to an idler pulley; and wherein the flame element is coupled to the idler pulley to produce rotary motion of the flame element.

31. The apparatus of claim 29, wherein the apparatus further comprises a blower coupled to the flame element to alter the position of the flame element.

32. The apparatus of claim 29, further comprising a light source positioned to direct light upon the flame element.

33. The apparatus of claim 29, wherein the flame element comprises a silk material.

34. The apparatus of claim 29, wherein the flame element comprises a body portion and an edge portion; and wherein the edge portion is treated with a stiffening material.

35. The apparatus of claim 29, wherein the enclosure comprises a front panel, a back panel, a bottom panel, a top panel and side panels; and wherein the back panel and side panels comprise a partial mirrored surface to produce a reflection of the flame element.

36. The apparatus of claim 29, further comprising a log set disposed within the chamber.

37. A method for simulating a flame of a fire, comprising the steps of:
providing a flame element; and
coupling the flame element to a mechanical means that moves the flame element from a fixed position.

38. The method of claim 37, wherein the mechanical means comprises an electric motor coupled to a drive pulley and a drive belt coupling the drive pulley to an idler pulley; and wherein the flame element is coupled to the idler pulley to produce rotary motion of the flame element.

39. The method of claim 37, further comprising the step of providing a blower positioned to move the flame element.

40. The method of claim 37, further comprising the step of providing a light source positioned to direct light upon the flame element.

41. The method of claim 37, wherein the flame element comprises a silk material.

42. The method of claim 37, further comprising the step of treating an edge portion of the flame element with a stiffening material.

43. A method for simulating a fire within a fireplace, comprising the steps of:
providing an enclosure, wherein the enclosure defines a chamber;
disposing a flame element within the chamber; and
coupling the flame element to a mechanical means that moves the flame element from a fixed position.

44. The method of claim 43, wherein the mechanical means comprises an electric motor coupled to a drive pulley and a drive belt coupling the drive pulley to an idler pulley; and wherein the flame element is coupled to the idler pulley to produce rotary motion of the flame element.

45. The method of claim 43, further comprising the step of providing a blower positioned to move the flame element.

46. The method of claim 43, further comprising the step of providing a light source positioned to direct light upon the flame element.

47. The method of claim 43, wherein the flame element comprises a silk material.

48. The method of claim 43, further comprising the step of treating an edge portion of the flame element with a stiffening material.
